(19) United States
(12) Patent Application Publication
(10) Pub. No.: US 2008/0041237 A1
(43) Pub. Date: Feb. 21, 2008

(54) AUTOMATIC EGG BOILER

(76) Inventor: STUART BONSELL, LONDON (GB)

Correspondence Address: BANNER & WITCOFF, LTD., 1100 13th STREET, N.W., SUITE 1200, WASHINGTON, DC, 20005-4051, US

(21) Appl. No.: 11/464,801

(22) Filed: Aug. 15, 2006

(51) Int. Cl. A47J 29/04

(52) U.S. Cl. 99/328; 99/327

(57) ABSTRACT

An automatic egg boiler has a water container 2, an electric heating element, a drive means able to move an egg on a platform 6 from a rest position at an open top of the container 2 down into heated water for a predetermined time interval and to lift the egg out of the water at the end of the interval. The unit includes a timer 8 and this allows the cooking process to run for a period which is able to be set before starting the operation.

This provides an egg boiler which has its own timer and thus is able to work without needing to be closely watched.

This invention is an automatic egg boiler. In the common household task of cooking a boiled egg, there is a need to lower the egg into a pan of warm or hot water, to boil the water for a predetermined time interval and then to remove the pan from the heat. The egg must be lifted promptly out of the water so that a specified duration of cooking will have been applied to the egg. The amount of cooking usually needs to be adjusted in accordance with the wishes of the person who is to eat the egg. Some people are critical of the degree of softness which is needed in the cooked egg and they would be dissatisfied if the egg texture was considered to be overcooked or hard. These people can be expected to require their eggs to be cooked for a specified number of minutes and seconds.

There is thus a problem which has to be overcome by the person cooking the egg in that this must be lowered into the boiling water for a particular time interval. In addition, the person cooking the egg needs to make a decision as to the length of this time interval and has to ensure that the heat source is removed upon expiry of the time. It is necessary therefore for the egg cooking operation to be closely supervised so that the correct result is achieved. If one has to carry out other tasks involved in the preparation of a meal, it is difficult to be able to give much attention to the correct timing of the egg when other work is being done.

It would be better if the egg could be cooked in a way which was at least semi-automatic so that the supervision effort needed to ensure correct timing would not be so critical. I have now discovered a means of and apparatus for cooking an egg which will be able to automatically terminate the boiling operation when a predetermined time interval has elapsed.

According to the invention, there is provided an automatic egg boiler comprising a water container, an electric heating element, a drive means able to move an egg to an open top of the container when actuated and an electronic timer.

The drive means may include a support platform for lowering an egg into the water container. The support platform may be motor driven. A drive motor for the platform may be connected to the electronic timer such that the egg will be lowered into the water at the start of the boiling operation and then raised from the water at the end of this operation.

The platform may comprise a screw and nut arrangement where the screw is driven by a shaft of the motor. The nut will therefore be moved along the screw by the action of the motor shaft and the platform will be attached to this nut for corresponding movement therewith. The screw may be located on the motor shaft so that the platform will be moved vertically by operation of the motor. The platform may be arranged so that the boiled egg will be raised to an upper surface level of the egg boiler at the conclusion of the cooking process. The platform may be provided with a concave upper surface to give a stable end mounting for an egg, when this is present.

The electronic timer may be arranged to interrupt an electric circuit to the element when a predetermined time interval has elapsed. The electronic timer may include a display readout window and a timer set control. A display in the window may be arranged to count down from a preset time interval during the cooking operation. The termination of the cooking operation may be indicated by an audible signal device. The egg boiler may additionally have a start switch arranged to initiate the working of the timer.

A control circuit for the egg boiler may include a temperature sensor for detecting the water temperature and switching for the platform motor, the heating element and the timer at suitable points in the boiling process.

A mains electrical connection for the egg boiler may be provided by a base plate which is located below the boiler unit and which supports an electrical connector to which the boiler unit may be coupled. The base plate may include a flexible electrical lead for connection to a mains electrical power socket.

By way of example, some particular embodiments of the invention will now be described with reference to the accompanying drawings, in which:

FIG. 1 is a perspective view of the egg boiler,

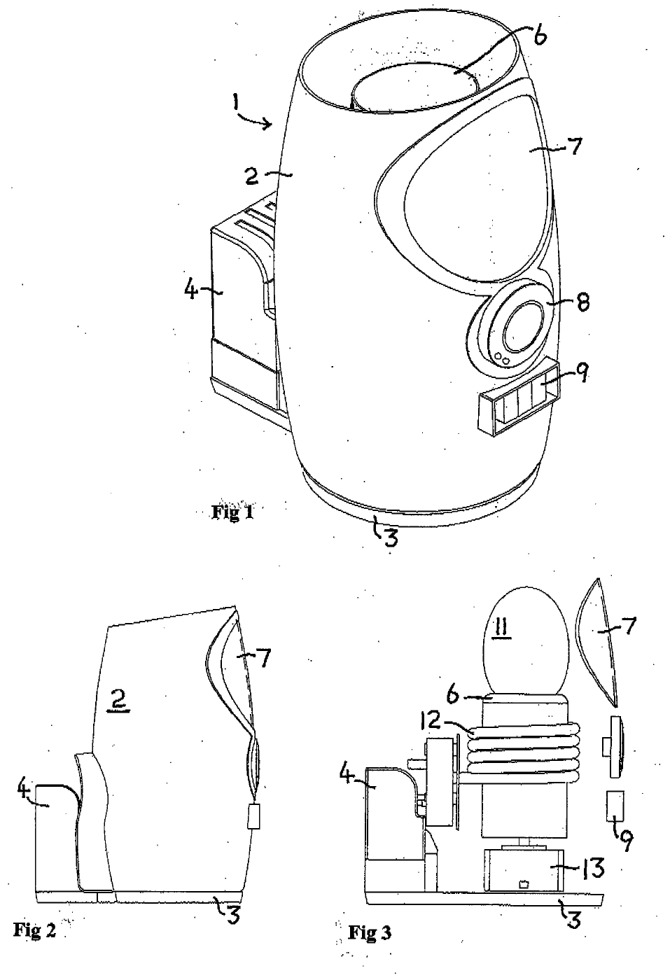

FIG. 2 is a side view,

FIG. 3 is a view of the article after removal of a body shell,

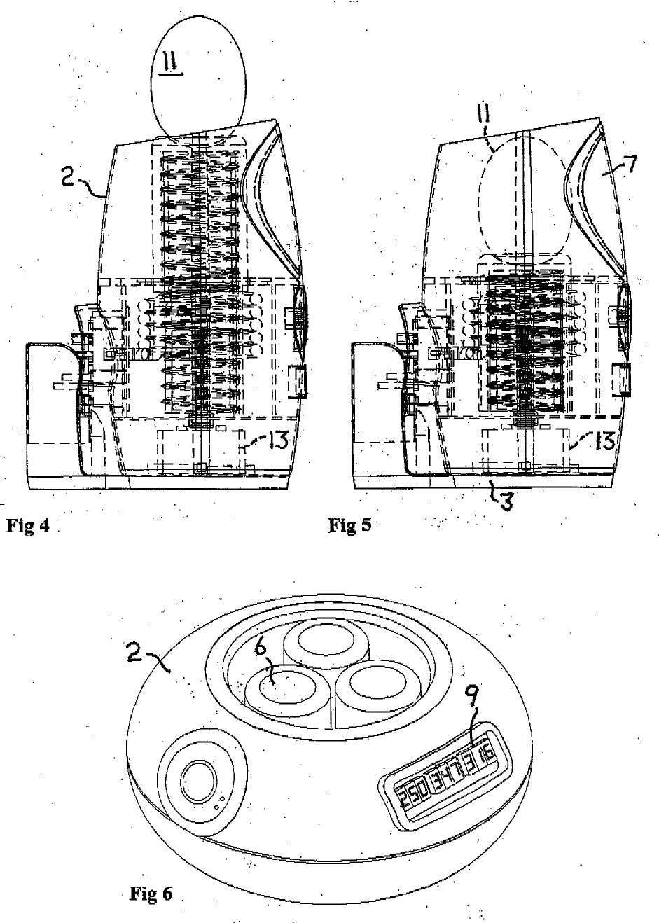

FIGS. 4 and 5 show the internal arrangement of the support platform in the raised and lowered positions, and,

FIG. 6 is a perspective view of a different model of the egg boiler.

As shown particularly in FIG. 1, the automatic egg boiler 1 was constructed as a small kitchen appliance with a smooth external body shell 2 formed of a moulded plastics material. The body shell 2 was of an injection moulded ABS plastics composition. The body shell 2 is supported on a base plate 3 which is coupled to an electrical connector 4 and the unit includes a flexible lead (not shown) for connection to a mains electrical socket. The body shell 2 is in fact a separate component from the base plate 3 and when these elements have been assembled, a three pin electrical plug which terminates an electrical heating element of the egg boiler will be entered into the electrical connector 4 of the base plate 3 so that a safe electrical connection will have been made.

FIGS. 1 and 2 show the body shell 2 located on the base plate 3 with the electrical connector 4 attached at a rear side of the base plate. On an upper surface of the body shell, an egg support platform 6 can be seen. The egg support platform 6 is provided with a concave upper surface so that it will form a stable mounting base for an egg. When the egg boiler is in the non-operating mode, the support platform 6 lies in a position generally flush with the upper surface of the body shell 2. During operation of the egg boiler, the platform 6 will be retracted downwards within the body shell 2 so that an egg on the platform will have become hidden by the outline of the shell.

The body shell 2 also has a transparent window 7 located on its surface as well as a time input dial 8 and a time readout display 9. The window 7 was made of an acrylic plastics material.

FIG. 3 shows the egg boiler components after the body shell has been removed. In this view, an egg 11 is shown standing on the egg support platform 6 when the platform is in the fully lowered position. The egg 11 is seen to be located just behind the transparent window 7 in a position where it would be fully immersed in a volume of water when this has been placed in the boiler device. The egg support platform 6 is situated within a spirally wound electric heating element 12 and this element is provided with electrical terminals which engage with the electrical connector 4 on the base plate so that the element can be energised as necessary.

The egg support platform 6 is made to be movable along its longitudinal axis by being constructed in a nut and bolt form with an internal bore on the platform acting as the nut part of the combination. The bolt part is provided by a screw which is located on the longitudinal axis of the support platform and which is caused to be rotated by a motor drive shaft of a miniature stepper motor 13. Actuation of this motor 13 will thus cause the egg support platform 6 to be lifted up until the platform reaches the upper surface level of the body shell 2. An opposite actuation of the motor allows the platform to be lowered to the position depicted in FIG. 3.

Since the motor 13 shaft passes through a bottom wall of the water container, the shaft is provided with a waterproof seal at this point.

A circuit board is mounted on the base plate 3 and this is arranged to control operation of the electrical heating element 12 for a predetermined time interval which is able to be set by a user on the time input dial 8 and with an electronic timer having the time readout display 9. There is also an ON/OFF switch which is located in the centre of the dial 8 and a water temperature sensor together with a control circuit for actuation of the motor. Additionally, an audio sounder will be operated to indicate when the egg cooking process has been completed.

FIG. 4 shows the internal arrangement of the egg support platform 6 when this is in the raised position and FIG. 5 is a similar view of the platform when this is in the lowered position.

In use of the automatic boiler, the user will plug the flexible lead from the connector 4 into a mains electrical socket and pour water into a boiling compartment surrounding the heating element 12 of the device. The volume of water required is only a small multiple of the volume of an egg so that this is an energy efficient way of cooking an egg as compared with using a full saucepan of water. The user will place an egg in an upright position on the egg support platform 6 at the top of the body shell. The user will then set the time interval for the boiling process at the preferred time that the egg will be required to cook. The preset time interval will be shown on the readout display 9. The user will next actuate the ON/OFF switch to initiate the cooking process. The operation begins with the actuation of the heating element 12 which will raise the temperature of the water and at the predetermined water temperature of 100° C. the motor 13 will be operated to lower the egg into the water. The heating element 12 will then be operated at a reduced power level so that the water will be maintained at a simmering temperature of 94° C. for the cooking process. The electronic timer will also start and the readout display 9 will count down from the preset time value until a time of zero is indicated. The motor 13 will then be used to raise the egg out of the water and the power supply to the heating element 12 will be interrupted. An audio sounder will be operated to indicate to the user that the cooking operation has been completed. The user will then be able to take the egg from its position on top of the body shell 2 and it can be easily transferred to an egg cup for immediate consumption. The egg will have been cooked perfectly as determined by the time interval that had been entered on the display.

The result of this is that the user will be able to take the cooked egg directly from the top of the body shell without any need to lift it carefully from a pan of hot water. The egg will have been cooked for a precise time in accordance with the user's setting of the electronic timer. The cooking will have been done automatically so that the user will be able to occupy themselves with other tasks whilst the cooking operation was in progress. There will also be a positive indication of when the cooked egg is ready.

FIG. 6 depicts an alternative model of the egg boiler which was designed for cooking three eggs at the same time. Each egg is provided with its own support platform 6 and timer readout display 9. This can enable each egg of the three to be cooked for a different set time interval if this is required.

The automatic egg boiler of the invention has been found to be comparatively easy and inexpensive to construct since it incorporates several standard components which are readily available. The device provides a way of accurately timing the boiling of an egg and means which will work without the boiling operation needing to be closely supervised by the user. Many of the devices proposed in the past for this task do not provide means for raising the egg out of the water at the end of the cooking process. It is thus expected that the automatic egg boiler will be found to be convenient for use in the kitchen alongside other automatic appliances such as the toaster and microwave oven.

Since the egg boiler is intended to heat the egg for boiling at a controlled temperature of 94° C. this will enable the production of steam to be limited and thus it will reduce any tendency to cause scalding of a user's band if this should be placed near the unit.

The foregoing description of embodiments of the invention has been given by way of example only and a number of modifications may be made without departing from the scope of the invention as defined in the appended claims. For instance, it is not essential that the body shell structure and the base plate should be made as separable components and the automatic egg boiler could alternatively be made in a one piece constriction. The unit may be provided with a switch to control operation of the audio sounder, and optionally a lid may be located at the top of the water container.

1. An automatic egg boiler comprising a water container, an electric heating element, a drive means able to move an egg to an open top of the container when actuated and an electronic timer.

2. An egg boiler as claimed in claim 1, in which the drive means includes a support platform for lowering an egg into the water container.

3. An egg boiler as claimed in claim 2, in which the support platform is connected to an electric motor.

4. An egg boiler as claimed in claim 3, in which the motor is coupled to said timer such that the platform may be actuated to lower and raise an egg in response to timer signals.

5. An egg boiler as claimed in claim 3 or 4, in which the support platform includes a screw and nut linkage whereby a motor drive shaft will be enabled to lower and raise said platform.

6. An egg boiler as claimed in any one of claims 2 to 5, in which the said support platform includes a concave upper surface effective to form a stable end recess for receiving an egg.

7. An egg boiler as claimed in any one of claims 1 to 6, having an electronic control circuit including switches for actuating the said drive means, heating element and timer.

8. An egg boiler as claimed in claim 7, in which the control circuit includes a water temperature sensor.

9. An egg boiler as claimed in claim 7 or 8 in which the control circuit includes means for detecting when the support platform has reached one or both of the limits of its travel.

10. An egg boiler as claimed in any one of claims 1 to 9, in which the timer has an optical display indicator arranged with means for adjusting the timer operation.

11. An egg boiler as claimed in claim 10, in which the optical display indicator is a digital display.

12. An egg boiler as claimed in any one of claims 1 to 11, in which the boiler unit includes a separable base plate carrying an electrical connector such that the heating element and motor will be connected thereto when in operation.

13. An egg boiler as claimed in claim 12, in which the base plate additionally carries a flexible lead and electrical power plug.

14. An egg boiler substantially as hereinbefore described with reference to any one of the accompanying drawings.
